(19) United States
(12) Patent Application Publication
(10) Pub. No.: US 2006/0107534 A1
(43) Pub. Date: May 25, 2006

(54) Portable handheld work apparatus

(75) Inventors: Johannes Menzel, Wernau (DE); Gunter Wolf, Oppenweiler (DE); Roland Schierling, Affalterbach (DE)

Correspondence Address: WALTER OTTESEN, PO BOX 4026, GAITHERSBURG, MD, 20885-4026, US

(73) Assignee: Andreas Stihl AG & Co. KG.

(21) Appl. No.: 11/286,398

(22) Filed: Nov. 25, 2005

(30) Foreign Application Priority Data
Nov. 25, 2004 (DE) 10 2004 056 919.3

(51) Int. Cl. B27B 17/02

(52) U.S. Cl. 30/383

(57) ABSTRACT

A portable handheld work apparatus includes a drive motor (1) and a vibration suppressor (2) which is rotatably driven by the drive motor (1). The vibration suppressor (2) compensates or absorbs translatory vibrations. The vibration suppressor includes suppression masses (4, 5, 6) for generating a targeted imbalance. The suppression masses (4, 5, 6) are arranged at a radius to the rotational axis (3) of the vibration suppressor (2). At least one suppression mass (5, 6) is mounted so as to be changeable in its position in dependence upon rpm.

### CROSS REFERENCE TO RELATED APPLICATION

This application claims priority of German patent application no. 10 2004 056 919.3, filed Nov. 25, 2004, the entire content of which is incorporated herein by reference.

### FIELD OF THE INVENTION

The invention relates to a portable handheld work apparatus such as a chain saw, cutoff machine, brushcutter or the like.

### BACKGROUND OF THE INVENTION

During operation of work apparatus of this kind, vibrations occur which are excited by a driven tool of the work apparatus. Additional vibrations are excited especially where the drive motor of the work apparatus is in the form of an internal combustion engine because of the moving masses of the engine. In general, these engines are single cylinder engines and have an engine running which is comparatively rough and burdened with vibrations. The vibrations, which are generated at the engine end, cannot be completely eliminated by balancing the moving engine parts. In total, oscillations caused by the tool and engine lead to vibrations which are disturbingly noticeable at the handles of the work apparatus. The handle end vibration can only be reduced to a limited extent with additional measures such as a vibration decoupling of the handles from the engine housing by means of antivibration elements.

U.S. Pat. No. 4,836,297 discloses a portable handheld work apparatus driven by an internal combustion engine wherein imbalance weights are mounted in a crankshaft assembly of the drive motor. An imbalance is deliberately caused by the imbalance weights on the crankshaft web and/or on the fan wheel. The imbalance is so dimensioned with respect to magnitude and phase position that the imbalance, as vibration suppressor, forms a balance or compensation for operation-caused translatory vibrations.

The targeted imbalance of the vibration suppressor results from the imbalance masses which are defined in accordance with phase angle and magnitude. The targeted imbalance of the vibration suppressor can be designed to an optimum of the equivalent oscillation value in order to reduce the vibration level at the handle locations. The imbalance operates to reduce specific oscillation forms from the handle system and from the antivibration system. The equivalent oscillation value results from the values of the representative operating conditions. These values are defined, for example, in motor-driven chain saws as idle rpm values, full-load rpm values and maximum rpm values. It has been shown that a vibration suppressor, which is optimized to the equivalent oscillation value, exhibits an effect which is, under some circumstances, insufficient in the above-mentioned individual operating states.

### SUMMARY OF THE INVENTION

It is an object of the invention to provide a portable handheld work apparatus having a vibration suppressor which is so improved that an improved suppression effect is ensured over a large operating parameter range.

The portable handheld work apparatus of the invention includes: a vibration suppressor for suppressing vibrations occurring during operation of the work apparatus; a drive motor driving the vibration suppressor; the vibration suppressor defining a rotational axis and including a suppression mass for generating an imbalance; the suppression mass being mounted at a radius to the rotational axis; and, the vibration suppressor further including a mounting arrangement for mounting the suppression mass so as to cause the suppression mass to be changeable in position in dependence upon rpm.

An arrangement is provided wherein at least one suppression mass of the vibration suppressor is mounted so as to be changeable in its position in dependence upon rpm. The suppression mass is especially configured to have a radius, which is changeable in dependence upon rpm and/or an rpm-dependent changing phase angle. A base position of the suppression mass can be fixed which achieves an optimal suppression effect for a defined rpm range. The suppression mass is mounted in such a manner with respect to radius to the rotational axis and phase angle that the translatory oscillation, which is excited by the suppression mass, approximately completely suppresses the operation-caused translatory excitation oscillation. For deviating rpm, that is, an rpm which increases or decreases, the operation-caused excitation spectrum changes in magnitude and/or phase. The rpm-controlled displacement of the suppression mass leads to a resulting imbalance which is changed with respect to the start position likewise in magnitude and/or phase. The rpm-dependent or rpm-controlled displacement or deflection can be so pregiven that the changed excitation spectrum is considered. An improved suppression effect can also be achieved for deviating rpm or load conditions.

In an advantageous embodiment, the suppression mass, which is changeable with respect to its position, is journalled by means of a pivot arm on the vibration suppressor. The pivot arm permits a precise, low wear and robust guidance of the suppression mass.

It is practical that the suppression mass is pretensioned radially inwardly referred to the rotational axis by means of a spring. A deflection path of the suppression mass radially outwardly is limited by a stop. A stepwise damper or suppressor adaptation is formed with simple means which is dependent upon rpm. Below a limit rpm, the pretensioned spring holds the suppression mass corresponding thereto in a radial inner position where it is immovably held. The position of the suppression mass is matched to the oscillation excitation below this limit rpm. When the limit rpm is exceeded, the pretensioning force of the spring is overcome as a consequence of the centrifugal force acting on the suppression mass. The suppression mass is moved radially outwardly against the assigned stop. The stop generates a defined positioning of the suppression mass in the upper rpm range and determines a position of the suppression mass which is matched to the oscillating behavior in the upper rpm range.

Advantageously, at least two suppression masses, which are changeable in their position, are each provided with different spring pretensioning. The different spring pretensioning is so selected that the individual suppression masses change sequentially with respect to their position in a cascading manner. A finely stepped, rpm-dependent displacement of the resulting imbalance in magnitude and phase is also possible which facilitates a finely stepped adaptation to the excitation frequency characteristic.

It is practical to provide one stationary suppression mass and at least one suppression mass which is moveable with respect to its position. A base matching can be achieved with the fixed suppression mass. The suppression masses, which are changeable with respect to their positions, function only to provide the adaptation to rpms which deviate from the base matching. The suppression masses, which are changeable in their positions, can be configured to be correspondingly small whereby a reliable, precise guidance is simplified even at high rpm levels.

In a practical embodiment, the suppression mass, which is changeable in its position, is mounted angularly offset to the stationary suppression mass. Even a radial displacement of the individual suppression masses effects a shift of the total mass center of gravity of the vibration suppressor in magnitude and phase whereby an adaptation of the suppression performance is made possible with kinematically simple means.

The vibration suppressor of the invention can be mounted at different component assemblies of the work apparatus which are rotatably driven. In one embodiment of the drive motor as an internal combustion engine, the vibration suppressor is advantageously mounted on a crankshaft assembly and especially on a fan wheel for generating a cooling air flow. The fan wheel is part of the crankshaft assembly. The coupling of the vibration suppressor to the crankshaft assembly ensures that the vibration suppressor operates with identical rpm or frequency as the excitation oscillations at least of the engine without the constructively provided phase position between excitation vibration and suppressor oscillation being able to change. A permanent suppression action is ensured. The fan wheel has a comparatively large diameter wherein correspondingly small suppression masses can be accommodated without additional need for space.

### BRIEF DESCRIPTION OF THE DRAWINGS

The invention will now be described with reference to the drawings wherein:

FIG. 1 is a perspective overview of a portable handheld work apparatus which is here shown, by way of example, as a chain saw having an internal combustion engine;

FIG. 2 shows a vibration suppressor mounted on the fan wheel of the work apparatus of FIG. 1 with a fixed suppression mass and two suppression masses, which are changeable in position, in a configuration for low rpms;

FIG. 3 shows the arrangement of FIG. 2 with a radially deflected suppression mass at full load; and, FIG. 4 shows the arrangement of FIGS. 2 and 3 with both displaceable suppression masses in radially deflected positions at the maximum rpm.

### DESCRIPTION OF THE PREFERRED EMBODIMENTS OF THE INVENTION

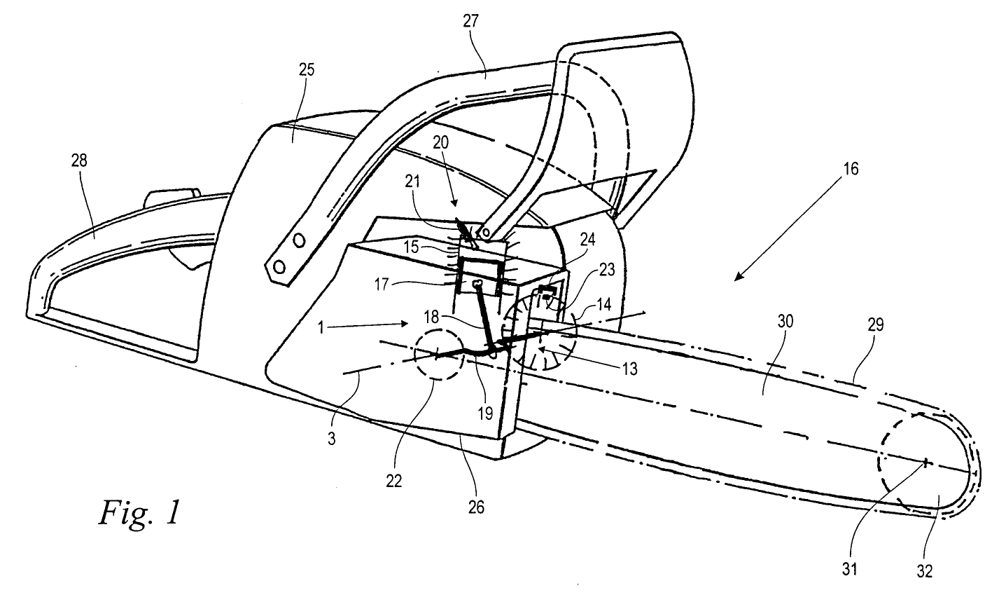

FIG. 1 is a schematic perspective view of a portable handheld work apparatus in the form of a chain saw 16 having a drive motor 1 for driving a saw chain 29. The drive motor 1 is configured as a two-stroke internal combustion engine. Any other desired portable handheld work apparatus, such as a brushcutter or the like, can be provided. The drive motor 1 can also be an electric motor. A two-stroke engine as well as a four-stroke engine can be utilized as the internal combustion engine.

In the embodiment shown, the drive motor 1 has a single cylinder 15 wherein a piston 17 is guided so as to reciprocate in the longitudinal direction. The piston 17 is connected to a crankshaft 19 by a connecting rod 18 for generating a rotational movement about a rotational axis 3.

The saw chain 29 runs along the edges of a guide bar 30. A guide wheel 32, which is rotatable about an axis 31, is provided at the end of the guide bar 30 facing away from the clutch 22 for changing the direction of the saw chain 29. In the region of the end of the guide bar 30 close to the engine, the saw chain 29 engages around a clutch 22 which is attached to an end of the crankshaft 19. The saw chain 29 is driven via the clutch 22 starting at a pregiven rpm of the crankshaft 19.

A fan wheel 14 is at the end of the combustion engine 1 and lies opposite the clutch 6. The fan wheel 14 is for cooling the engine especially in the region of the cylinder 15 and is driven by the crankshaft 19. The fan wheel carries an ignition magnet 23 which passes by a housing-fixed ignition coil 24, which is radially on the outside, with the rotation of the fan wheel. In the ignition coil 24, an ignition voltage is generated for a spark plug 21 mounted in the cylinder 15 whereby an air/fuel mixture in the interior of the cylinder 15 is ignited. Spark plug 21, ignition magnet 23 and ignition coil 24 are parts of an ignition system 20.

The clutch 22, the crankshaft 19 and the fan wheel 14 are fixedly connected to each other. They form a crankshaft assembly 13 with a uniform rpm during operation. The drive motor 1 with its crankshaft assembly 13 is mounted in a motor housing 25. The clutch 22 is covered by a clutch cover 26. Forward and rearward handles (27, 28) are attached to the motor housing 25 for guiding the chain saw 16.

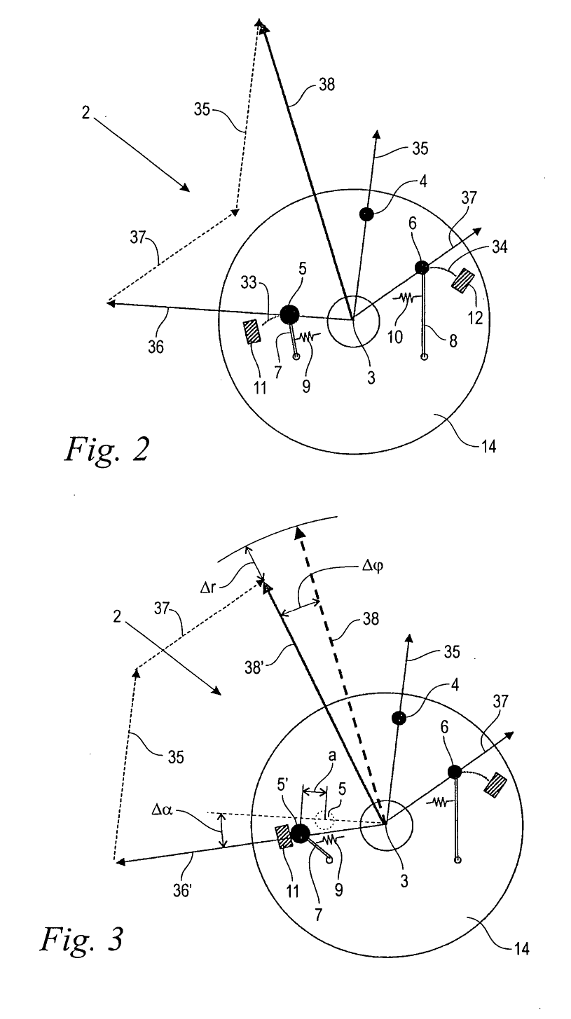

FIG. 2 shows the fan wheel 14 of the crankshaft assembly 13 in a schematic plan view viewed in the direction of the rotational axis 3. The fan wheel 14 is part of the crankshaft assembly 13 of FIG. 1. A vibration suppressor 2 is arranged on the fan wheel 14. During operation of the portable handheld work apparatus, the vibration suppressor 2 rotates about the same rotational axis and with the same rpm as the crankshaft assembly 13 of FIG. 1. The vibration suppressor 2 can also be mounted on the crankshaft 19 or on the clutch 22 (FIG. 1).

In the embodiment shown, the vibration suppressor 2 includes overall three suppression masses (4, 5, 6) for generating a targeted imbalance. The suppression masses (4, 5, 6) are arranged at a radius to the rotational axis 3. The first suppression mass 4 lies fixed on the fan wheel 14. The two additional suppression masses (5, 6) are pivotally journalled on vibration suppressor 2 (that is, the fan wheel 14) by means of respective pivot arms (7, 8). Springs (9, 10) act on the pivot arms (7, 8), respectively, and pull the corresponding pivot arm (7, 8) with the corresponding suppression mass (5, 6) under pretension radially inwardly into the position shown. The suppression masses (5, 6) are supported by stops (not shown) radially inwardly against the pretensioning force of the springs (9, 10).

The suppression masses (4, 5, 6) generate centrifugal forces with the rotation of the illustrated arrangement at idle rpm and in a mid rpm range. The centrifugal forces are indicated by respective arrows (35, 36, 37) and are directed radially outwardly from the rotational axis 3. An arrow 38, which shows the resultant centrifugal force, can be formed from a geometric addition of the arrows (35, 36, 37). The suppression masses (4, 5, 6) are shown angularly offset with respect to each other and effect a center of gravity shift of the balanced fan wheel 14 away from the rotational axis 3 radially outwardly in the direction of the arrow 38. It is in this direction of arrow 38 that the resulting imbalance or centrifugal force also acts.

As a consequence of the rotation of the arrangement shown, a translatory oscillation arises which, in magnitude and phase, is so matched to the excitation oscillation of the work apparatus of FIG. 1 that both oscillations mutually cancel or at least approximately mutually cancel in the low rpm range. The translatory oscillation acts within the fan wheel plane or radially to the rotational axis 3.

Above constructively predetermined limit rpms, the moveably supported suppression masses (5, 6) can move radially outwardly along arcuately-shaped displacement paths (33, 34). The displacement paths (33, 34) are limited outwardly by assigned stops (11, 12), respectively.

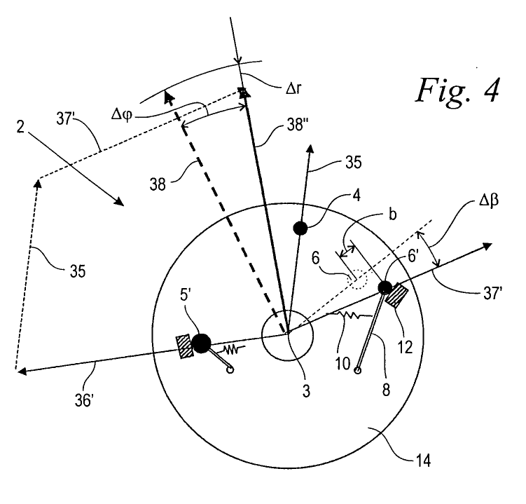

FIG. 3 shows the arrangement of FIG. 2 at full-load operation. At full-load operation, the fan wheel 14 with the vibration suppressor 2 rotates at increased rpm. The application of an external load (for example, on the saw chain 29 (FIG. 1)) causes, however, the full-load rpm to be less than the maximum rpm attainable without load.

The suppression masses (5, 6), the corresponding springs (9, 10) and their geometric relative arrangement are so matched to each other that a different effective spring pretensioning results at the two suppression masses (5, 6). The effective spring pretensionings are so selected that the centrifugal force, which acts on the suppression mass 5, is sufficient in order to overcome the pretensioning of the assigned spring 9. The pivot arm 7 pivots under the action of the centrifugal force in common with the suppression mass 5 into the position identified by reference numeral 5′. This position is radially outwardly delimited by the stop 11. The suppression mass 5′ is displaced with a radial deflection (a) and a phase angle changed by Δα compared to its position shown in FIG. 2 at lower rpm. A centrifugal force, which is shown by arrow 36′, acts on the suppression mass 5′.

The rpm increased relative to FIG. 2 is, however, insufficient to deflect the additional suppression mass 6 against its higher effective spring pretensioning. In the scaled diagram shown, the arrows (35, 37) for showing the centrifugal forces have correspondingly not changed in magnitude and direction. These centrifugal forces act on the undisplaced suppression masses (4, 5).

A geometric addition of the arrows (36′, 35 and 37) leads to a resultant centrifugal force or unbalance force (shown by arrow 38′) which is changed by a phase change angle Δφ and a radius Δr relative to the arrow 38 of FIG. 2. This change is adapted to the excitation oscillation changed in magnitude and phase relative to the idle range whereby an improved cancelling or suppression action is achieved.

In the absence of an external load, a further rpm increase can occur up to a maximum rpm. In this situation, a configuration of the vibration suppressor 2 of FIG. 4 results. The increased centrifugal forces, which act on the additional suppression mass 6, are sufficient to overcome the inwardly-directed pretension force of the assigned spring 10. The pivot arm 8 with the suppression mass 6 is deflected radially outwardly up to the position delimited by the stop 12 and identified by reference numeral 6′. Compared to its original position identified by reference numeral 6, the suppression mass 6′ is displaced by a radial deflection path (b) as well as by a deflection angle Δβ. A centrifugal force, which is shown by arrow 37′, acts on the suppression mass 6′. This damping force, when geometrically added to arrows 36′ and 35, leads to a resultant centrifugal force 38′. The phase change angle Δφ relative to the original position of arrow 38 of FIG. 2 runs here in the opposite direction relative to the arrangement of FIG. 3 by way of example. The radial difference Δr which adjusts, is, by way of example, shown with a negative amount. It can also be practical to configure the arrangement so that a longer arrow 38′ and/or 38″ adjusts relative to the original arrow 38 with a positive Δr. The above-mentioned normalized illustration of the centrifugal forces means that the arrows, which are assigned to the centrifugal forces, are an index for the imbalance magnitude of the product of mass and radius, for example, in the unit gmm. The actual imbalance force changes with the rpm referred to a fixed imbalance quantity.

The embodiment shown has a suppression mass 4, which is fixed on the vibration suppressor 2, and two additional suppression masses (5, 6) which change with respect to their positions. Another number of changeable suppression masses (5, 6) can be practical. Likewise, it can be advantageous to do without a fixed suppression mass 4 and, in total, provide at least one suppression mass (5, 6) changeable with respect to its position.

In the embodiment shown, the suppression masses (5, 6) are so pivotally guided that they change their positions with respect to radius and phase angle in dependence upon the occurring rpm. As a result, a change of the resulting imbalance adjusts with respect to magnitude and phase. A comparable effect can also be obtained with a displacement of the suppression masses (5, 6) which is exclusively radial or exclusively tangential. Simple linear guides can also be provided in lieu of the shown guidance with pivot arms (7, 8) shown by way of example. For example, it can be practical to arrange steel balls with pressure springs in corresponding tubes. Leaf springs for supporting and holding the suppression masses (5, 6) can be practical in lieu of the pivot arms (7, 8) and their springs (9, 10).

It is understood that the foregoing description is that of the preferred embodiments of the invention and that various changes and modifications may be made thereto without departing from the spirit and scope of the invention as defined in the appended claims.

What is claimed is:

1. A portable handheld work apparatus comprising:
a vibration suppressor for suppressing vibrations occurring during operation of said work apparatus;
a drive motor driving said vibration suppressor;
said vibration suppressor defining a rotational axis and including a suppression mass for generating an imbalance;
said suppression mass being mounted at a radius to said rotational axis; and,
said vibration suppressor further including a mounting arrangement for mounting said suppression mass so as to cause said suppression mass to be changeable in position in dependence upon rpm.

2. The portable handheld work apparatus of claim 1, wherein said suppression mass is mounted so as to permit a change of radius.

3. The portable handheld work apparatus of claim 2, wherein said suppression mass is mounted so as to permit a change of phase angle.

4. The portable handheld work apparatus of claim 3, wherein said mounting arrangement includes a pivot arm for pivotally supporting said suppression mass on said vibration suppressor.

5. The portable handheld work apparatus of claim 4, wherein said mounting arrangement further includes: a spring for pretensioning said suppression mass radially inwardly relative to said rotational axis; and, a stop for limiting a deflection path of said suppression mass in a radially outward direction.

6. The portable handheld work apparatus of claim 5, wherein said suppression mass is a first suppression mass and said spring is a first spring having a first pretensioning force; said vibration suppressor includes a second suppression mass; and, said mounting arrangement includes a second spring associated with said second suppression mass and having a pretensioning force different from said first pretensioning force.

7. The portable handheld work apparatus of claim 4, wherein said vibration suppressor further includes a fixed suppression mass.

8. The portable handheld work apparatus of claim 7, wherein said suppression mass, which is changeable in position, is mounted so as to be angularly offset from said fixed suppression mass.

9. The portable handheld work apparatus of claim 1, wherein said drive motor is an internal combustion engine and said engine has a crankshaft assembly with said vibration suppressor mounted on said crankshaft assembly.

10. The portable handheld work apparatus of claim 9, wherein said crankshaft assembly includes a fan wheel for generating a flow of cooling air for cooling said engine; and, said vibration suppressor is mounted on said fan wheel.

11. The portable handheld work apparatus of claim 1, wherein said work apparatus includes a chain saw, cutoff machine, brushcutter or the like.
